(19) United States
(12) Patent Application Publication
(10) Pub. No.: US 2022/0250749 A1
(43) Pub. Date: Aug. 11, 2022

(54) DISCHARGE APPARATUS, UNMANNED AERIAL VEHICLE AND DISCHARGE METHOD

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/628,207

(22) PCT Filed: Jul. 22, 2020
(86) PCT No.: PCT/JP2020/028581

§ 371 Date: Jan. 18, 2022

(30) Foreign Application Priority Data
Jul. 23, 2019 (JP) 2019-135193
Nov. 8, 2019 (JP) 2019-203052

(51) Int. Cl. B64D 1/18; B64C 39/02; B65D 83/42; A01M 7/00

(52) U.S. Cl. CPC B64D 1/18; B64C 39/024; B64C 2201/12; A01M 7/0032; B65D 83/42

(57) ABSTRACT

Provided is a discharge apparatus using an aerosol container, including a holding container for holding contents, a pressurizing unit configured to inject a filling material within the holding container by the aerosol container to pressurize the holding container, and a discharge unit configured to discharge the contents to the outside of the holding container. An unmanned aerial vehicle including the above-described discharge apparatus is also provided. A discharge method using an aerosol container, comprising: holding contents of a holding container; injecting a filling material within the holding container by the aerosol container to pressurize the holding container; and discharging the contents to the outside of the holding container is also provided.

### BACKGROUND

### 1. Technical Field

The present invention relates to a discharge apparatus, an unmanned aerial vehicle and a discharge method.

### 2. Related Art

Conventionally, when scattering a scattering material such as a pesticide from an aircraft, the scattering material is discharged using a pump or the like from a container holding the scattering material. Also, a scattering method using a cylinder having high pressure air enclosed therein is known, the cylinder being mounted to the aircraft (for example, see Patent document 1).

[Patent document 1] Japanese Patent Application Publication No. H9-86499

### Technical Problem

However, in the conventional scattering method, since it is necessary to mount a pump or a cylinder with heavy weight or the like to the vehicle, a flight of the aircraft may be affected.

### GENERAL DISCLOSURE

In a first aspect of the present invention, provided is a discharge apparatus using an aerosol container, including a holding container for holding contents, a pressurizing unit configured to inject a filling material within the holding container by the aerosol container to pressurize the holding container, and a discharge unit configured to discharge the contents to the outside of the holding container.

The discharge apparatus may include a first switching unit configured to switch whether the holding container and the pressurizing unit communicate with each other.

The discharge apparatus may include an inner pressure detection unit configured to detect an inner pressure of the holding container, and a control unit configured to, depending on the detection result of the inner pressure detection unit, control an operation of the first switching unit.

The control unit may open the first switching unit if the inner pressure of the holding container falls below a predetermined lower threshold, and may close the first switching unit when the inner pressure of the holding container exceeds a predetermined upper threshold.

The discharge apparatus may include a second switching unit configured to switch whether the holding container and the discharge unit communicate with each other, and may open the second switching unit at the time of discharging from the discharge unit.

The discharge apparatus may include a supplying container configured to hold the contents and to supply the contents to the holding container.

The discharge apparatus may include a third switching unit configured to switch whether the supplying container and the holding container communicate with each other.

The discharge apparatus may include a remaining amount detection unit configured to detect a remaining amount of the contents which the holding container is holding, and a control unit configured to, depending on the detection result of the remaining amount detection unit, control an operation of the third switching unit.

The holding container may have a higher pressure resistance than the supplying container.

The supplying container may have a larger capacity than the holding container.

The supplying container may include a first supplying unit configured to supply a first content, and a second supplying unit configured to supply a second content which is different from the first content.

The holding container may include a first connecting unit connected to the pressurizing unit, and a second connecting unit connected to the discharge unit. In the holding container, the first connecting unit may be provided closer to an upper surface side than the second connecting unit.

The holding container may further include an air releasing unit configured to depressurize the holding container.

The pressurizing unit may include at least one of liquefied gas or compressed gas.

The discharge apparatus may include a temperature regulating unit configured to regulate the temperature of the contents in the holding container.

The discharge apparatus may include a stirring unit configured to stir the contents of the holding container.

In a second aspect of the present invention, provided is an unmanned aerial vehicle including the above-described discharge apparatus.

In a third aspect of the present invention, provided is a discharge method using an aerosol container, including: holding contents of a holding container; injecting a filling material within the holding container by the aerosol container to pressurize the holding container; and discharging the contents to the outside of the holding container.

The method may include holding the contents to supply the contents to the holding container, pressurizing the holding container after the supplying, and discharging the contents to the outside of the holding container after the pressurizing.

The method may further include depressurizing the holding container.

The summary clause does not necessarily describe all necessary features of the embodiments of the present invention. The present invention may also be a sub-combination of the features described above.

### BRIEF DESCRIPTION OF THE DRAWINGS

FIG. 1A shows one example of a front view of an unmanned aerial vehicle 100.

FIG. 1B shows one example of a left side view of the unmanned aerial vehicle 100 according to FIG. 1A.

FIG. 2 shows one example of a steering system 300 of the unmanned aerial vehicle 100.

FIG. 3A shows one example of a discharge apparatus 500 in the unmanned aerial vehicle 100.

FIG. 3B shows one example of a configuration of a pressurizing unit 520.

FIG. 4 shows another example of the discharge apparatus 500 in the unmanned aerial vehicle 100.

FIG. 5 shows a still another example of the discharge apparatus 500 in the unmanned aerial vehicle 100.

FIG. 6 is a flowchart showing one example of an operation of the discharge apparatus 500 according to FIG. 3A.

FIG. 7 is a flowchart showing one example of an operation of the discharge apparatus 500 according to FIG. 4.

### DESCRIPTION OF EXEMPLARY EMBODIMENTS

Hereinafter, the present invention will be described by way of embodiments of the invention, but the following embodiments do not limit the invention according to the claims. In addition, not all combinations of features described in the embodiments are essential to the solution of the invention.

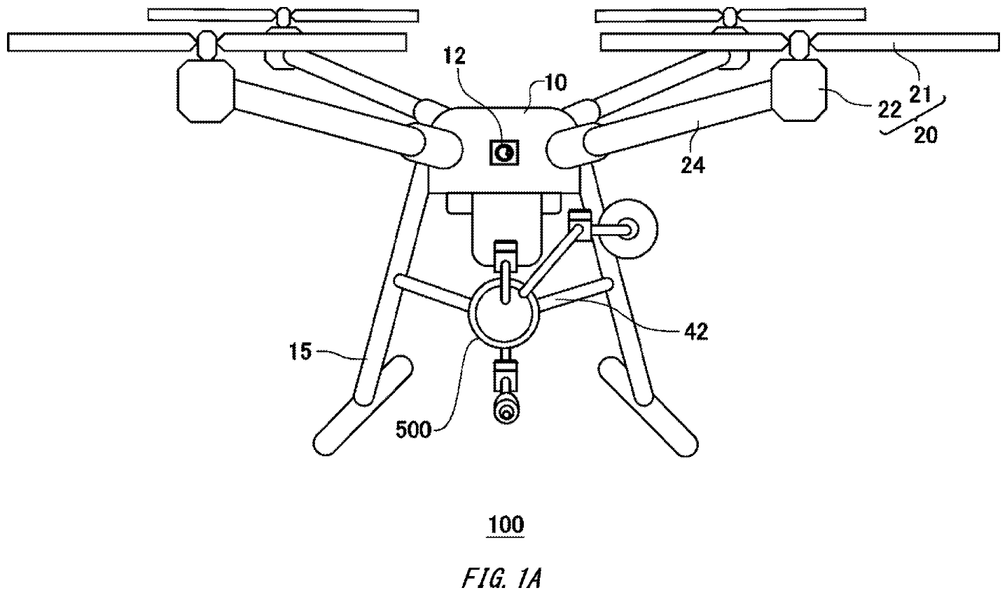

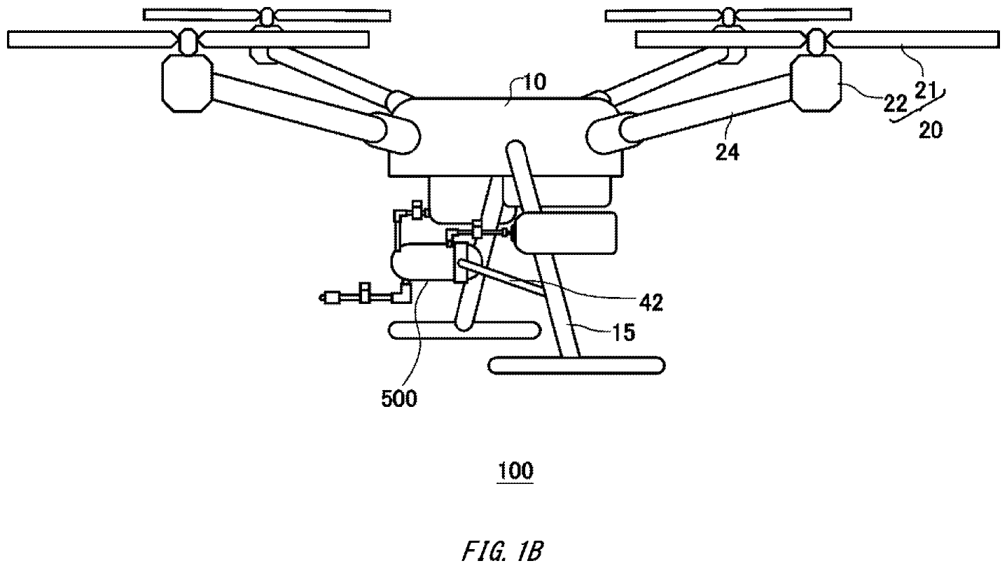

FIG. 1A shows one example of a front view of an unmanned aerial vehicle 100. FIG. 1B shows one example of a left side view of the unmanned aerial vehicle 100 according to FIG. 1A.

The unmanned aerial vehicle 100 is an aircraft which flies in the air. The unmanned aerial vehicle 100 in the present example includes a main body unit 10, a propulsion unit 20, and a discharge apparatus 500. Note that, in the present specification, a surface provided with a camera 12 in the main body unit 10 is referred to as a front side of the unmanned aerial vehicle 100, but the flight direction is not limited to the direction of the front side.

The main body unit 10 stores various types of control circuit and power supplies or the like of the unmanned aerial vehicle 100. Also, the main body unit 10 may function as a structure, which couples the components of the unmanned aerial vehicle 100 each other. The main body unit 10 of the present example is coupled to the propulsion unit 20. The main body unit 10 of the present example includes the camera 12.

The camera 12 is provided on a side surface of the main body unit 10. The camera 12 captures an image of the front side of the unmanned aerial vehicle 100. In one example, the video captured by the camera 12 is transmitted to a terminal device of the unmanned aerial vehicle 100. A pilot of the unmanned aerial vehicle 100 may operate the unmanned aerial vehicle 100 based on the video captured by the camera 12. Also, the pilot of the unmanned aerial vehicle 100 may steer the unmanned aerial vehicle 100 while directly seeing the unmanned aerial vehicle 100. Note that, the unmanned aerial vehicle 100 may include, in addition to the camera 12, another movable camera (not shown) which is used to control a discharge direction of the discharge apparatus 500, for example.

The propulsion unit 20 propels the unmanned aerial vehicle 100. The propulsion unit 20 has a rotary wing 21 and a rotation drive unit 22. The unmanned aerial vehicle 100 of the present example includes four propulsion units 20. The propulsion unit 20 is mounted on the main body unit 10 via an arm unit 24. Note that, the unmanned aerial vehicle 100 may be an aircraft including a fixed wing.

The propulsion unit 20 obtains propulsive force by rotating the rotary wing 21. There are four rotary wings 21 centered on the main body unit 10, but the arrangement method of the rotary wing 21 is not limited to the present example. The rotary wing 21 is provided on a tip of the arm unit 24 via the rotation drive unit 22.

The rotation drive unit 22 has a power source such as a motor, and drives the rotary wing 21. The rotation drive unit 22 may have a brake mechanism of the rotary wing 21. The rotary wing 21 and the rotation drive unit 22 may be directly mounted on the main body unit 10 with the arm unit 24 being omitted.

The arm unit 24 is provided extending radially from the main body unit 10. The unmanned aerial vehicle 100 of the present example includes four arm units 24 provided corresponding to the four propulsion units 20. The arm unit 24 may be fixed or movable. Another component such as a camera may be fixed on the arm unit 24.

A supporting frame 42 couples the main body unit 10 and the discharge apparatus 500. The supporting frame 42 may be fixed or movable. The supporting frame 42 may be a gimbal for controlling the location of the discharge apparatus 500 in three axial directions. In one example, the supporting frame 42 adjusts the discharge direction of the discharge apparatus 500 by displacing the location of the discharge apparatus 500. As shown in FIG. 1A and FIG. 1B, the supporting frame 42 may couple a holding container 510 (described below) of the discharge apparatus 500 and a leg 15 of the unmanned aerial vehicle 100, but it may couple another section of the discharge apparatus 500 and another section of the unmanned aerial vehicle 100. Also as shown in FIG. 1A and FIG. 1B, in addition to coupling of the holding container 510 of the discharge apparatus 500 to the leg 15 of the unmanned aerial vehicle 100 by the supporting frame 42, a pressurizing unit 520 of the discharge apparatus (described below) may be directly mounted to the leg 15. In addition, the discharge direction of the discharge apparatus 500 may be adjusted by making the supporting frame 42 fixed and making a discharge unit 530 (described below) of the discharge apparatus 500 movable.

The leg 15 is configured to be coupled to the main body unit 10, and hold the posture of the unmanned aerial vehicle 100 at the time of landing. The leg 15 is configured to hold the posture of the unmanned aerial vehicle 100 in a state where the propulsion unit 20 is stopped. The unmanned aerial vehicle 100 of the present example has two legs 15.

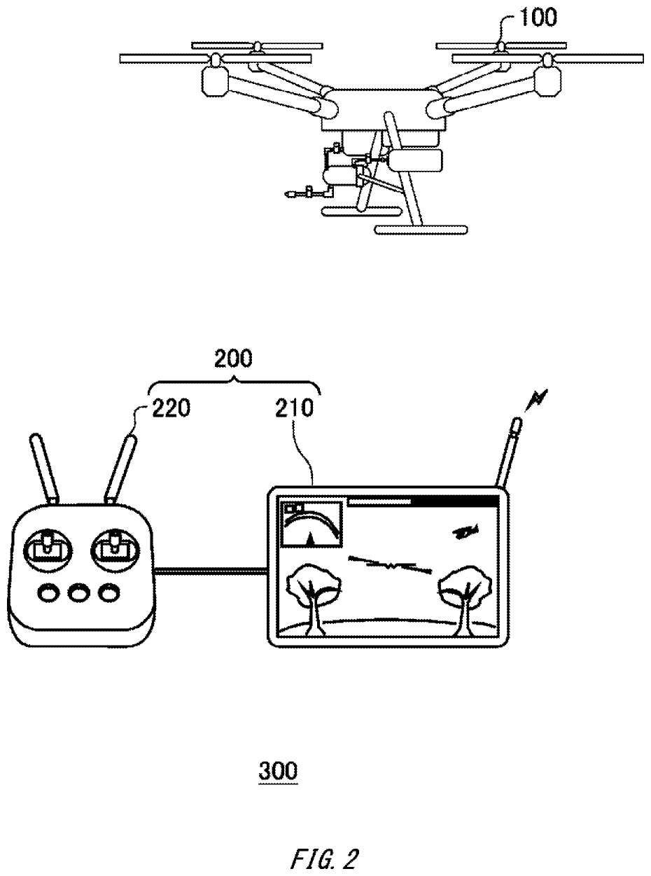

FIG. 2 shows one example of a steering system 300 of the unmanned aerial vehicle 100. The steering system 300 of the present example includes the unmanned aerial vehicle 100 and a terminal device 200. The terminal device 200 includes a display unit 210 and a controller 220.

The display unit 210 displays a video taken by a camera mounted on the unmanned aerial vehicle 100. The display unit 210 may display a video taken by the camera 12. The display unit 210 may directly communicate with the unmanned aerial vehicle 100, or may indirectly communicate with the unmanned aerial vehicle 100 via the controller 220. The display unit 210 may be connected to an external server.

The controller 220 is operated by the user and steers the unmanned aerial vehicle 100. In addition to the flight of the unmanned aerial vehicle 100, the controller 220 may instruct discharge of the contents performed by the discharge apparatus 500. The controller 220 may be connected to the display unit 210 in a wired or wireless manner. A plurality of controllers 220 may be provided to be separately used for steering the unmanned aerial vehicle 100 and controlling the discharge of the discharge apparatus 500.

Note that the user of the present example manually steers the unmanned aerial vehicle 100 using the terminal device 200. However, the user may steer automatically by program, rather than steering manually. In addition, the user may steer the unmanned aerial vehicle 100 while directly seeing the unmanned aerial vehicle 100 without using the screen which is displayed on the display unit 210. Also, the user may automatically control the steering of the unmanned aerial vehicle 100 and manually operate the discharge of the discharge apparatus 500.

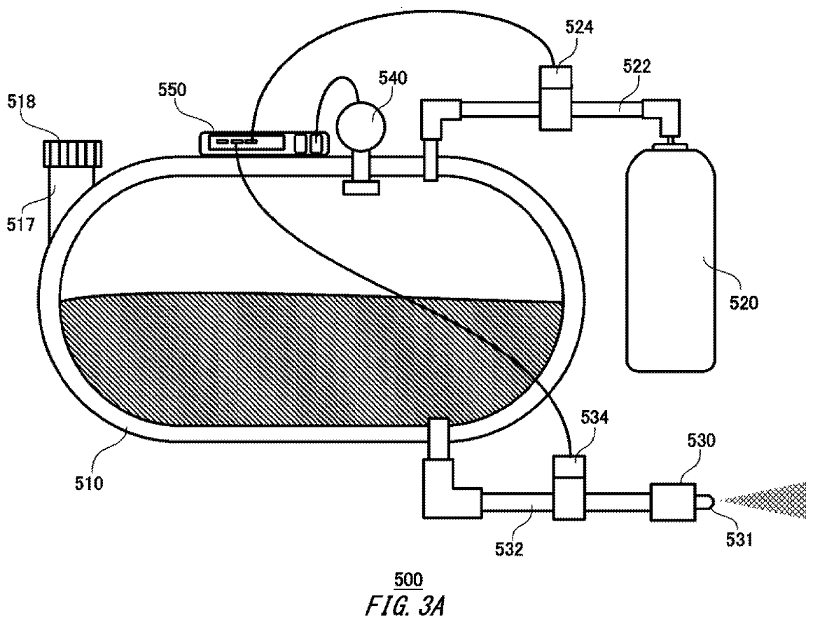

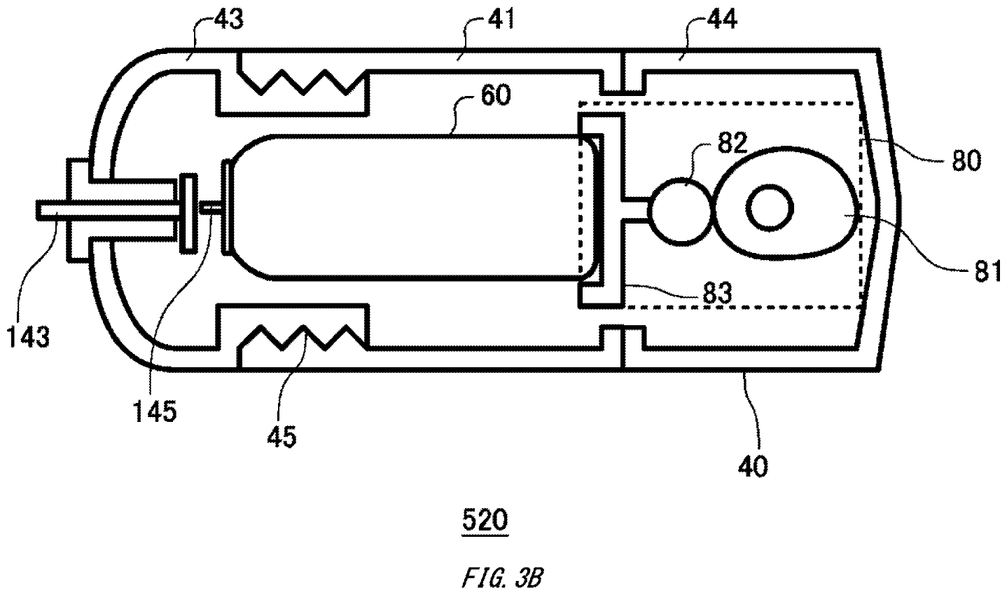

FIG. 3A shows one example of a discharge apparatus 500 in the unmanned aerial vehicle 100.

The discharge apparatus 500 includes a holding container 510, a pressurizing unit 520, a discharge unit 530, an inner pressure detection unit 540, and a control unit 550. The holding container 510 is connected to the pressurizing unit 520 by the first connecting unit 522, and connected to the discharge unit 530 by the second connecting unit 532. The first connecting unit 522 has a first switching unit 524 between the holding container 510 and the pressurizing unit 520, and the second connecting unit 532 has a second switching unit 534 between the holding container 510 and the discharge unit 530. The first switching unit 524 and the second switching unit 534 are solenoid valves, for example. The first switching unit 524, the second switching unit 534, and the inner pressure detection unit 540 are electrically connected to the control unit 550 via a control wire such as a conducting wire.

The holding container 510 is configured to hold the contents to be discharged from the discharge apparatus 500. The holding container 510 is made from a composite material such as metal or fibre-reinforced plastic, for example, and has a pressure resistance that is not damaged due to pressurizing by the pressurizing unit 520. The contents may be any of liquid, gas or solid. The contents may be in a state of such as powder, particle or gel. The contents may include pesticide or repairing agent. The holding container 510 has a holding container inlet 517 for supplementing the contents, and a holding container cap 518 for closing the holding container inlet 517.

The pressurizing unit 520 injects a filling material into the holding container 510 by an aerosol container to pressurize the holding container 510. A detailed components and injecting operation of the pressurizing unit 520 will be described below.

The discharge unit 530 is configured to discharge the contents of the holding container 510 to the outside of the holding container 510. The discharge unit 530 is one example of nozzles for discharging the contents. The discharge unit 530 has a discharge outlet 531 for discharging the contents of the holding container 510. The orientation of the discharge outlet 531 may be freely controlled depending on the direction in which the user wants to discharge. The discharge outlet 531 may be designed to eject the contents radially, for example, to scatter them in a relatively wide region, or may be designed to eject the contents in a linear shape, for example, to intensively scatter them in a relatively narrow region.

The filling material injected by the pressurizing unit 520 is supplied into the holding container 510 through the first connecting unit 522, to pressurize the holding container 510. The contents of holding container 510 are pushed out by this pressurizing, and they are discharged from the discharge unit 530 through the second connecting unit 532 to the outside.

The first switching unit 524 is configured to switch whether the holding container 510 and the pressurizing unit 520 communicate with each other, by opening and closing depending on an electrical signal from the control unit 550.

In the same manner, the second switching unit 534 is configured to switch whether the holding container 510 and the discharge unit 530 communicate with each other, by opening and closing depending on the electrical signal from the control unit 550.

The inner pressure detection unit 540 detects the inner pressure of the holding container 510 to output the detected inner pressure of the holding container 510 to the control unit 550.

The control unit 550 may control the operation of the first switching unit 524 depending on the detection result of the inner pressure detection unit 540. For example, if a remaining amount of the contents of the holding container 510 is reduced and the inner pressure of the holding container 510 falls below a predetermined lower threshold, the control unit 550 may open the first switching unit 524 to make the holding container 510 and the pressurizing unit 520 communicate with each other, thereby conduct the pressurizing which is performed by the pressurizing unit 520. Herein, it should be noted that the operation performed by the pressurizing unit 520 to inject the filling material for pressurizing the holding container 510 may be performed before opening the first switching unit 524 or may be performed after opening the first switching unit 524. Moreover, when the inner pressure of the holding container 510 exceeds a predetermined upper threshold due to the pressurizing performed by the pressurizing unit 520, the control unit 550 may close the first switching unit 524 to stop the pressurizing which is performed by the pressurizing unit 520.

When the contents of the holding container 510 needs to be discharged from the discharge unit 530, the control unit 550 may open the second switching unit 534 to make the holding container 510 and the discharge unit 530 communicate with each other, thereby perform the discharge from the discharge unit 530. At this time, if the inner pressure of the holding container 510 is high enough, the contents of the holding container 510 are discharged from the discharge unit 530.

A connection position of the holding container 510 and the first connecting unit 522 may be provided closer to the upper side than a connection position of the holding container 510 and the second connecting unit 532. In the example shown in FIG. 3A, the first connecting unit 522 is provided on the upper surface of the holding container 510. In this way, the first connecting unit 522 does not contact the contents of the holding container 510, so that the first connecting unit 522 can be prevented from being contaminated by the contents.

FIG. 3B shows one example of a configuration of a pressurizing unit 520. FIG. 3B shows a cross-sectional view of the pressurizing unit 520. The pressurizing unit 520 includes a container holding unit 40. The container holding unit 40 is configured to hold an aerosol container 60 filled with a filling material to be injected from the pressurizing unit. In one example, the container holding unit 40 is a sleeve in a cylindrical shape for accommodating the aerosol container 60. The material of container holding unit 40 is not limited as long as it can maintain the shape of accommodation unit for accommodating the aerosol container 60. For example, the material of the container holding unit 40 includes metal such as aluminum, plastic, or materials with high intensity and light weight such as carbon fiber. Also, the material of the container holding unit 40 is not limited to hard materials, but also may include soft materials, for example, rubber materials such as silicone rubber or urethane foam. Note that the container holding unit 40 may include a heating mechanism for heating the aerosol container 60 or keeping the temperature thereof. The container holding unit 40 of the present example includes a main body 41, a first end cover unit 43, and a second end cover unit 44. In addition, the container holding unit 40 includes a discharge drive unit 80 for controlling the discharge from the aerosol container 60.

The aerosol container 60 is configured to inject the filling material filled therein by a gas pressure of filling material itself. For example, the aerosol container 60 injects the filling material by a gas pressure of liquefied gas or compressed gas filled therein. The aerosol container 60 of the present example is a metal-made aerosol can. The aerosol container 60 may be a plastic container having a pressure resistance. The aerosol container 60 is mounted in a state where it is accommodated in the container holding unit 40.

Note that, as the filling material, liquefied gas such as hydrocarbon (liquefied petroleum gas) (LPG), dimethylether (DME) and fluorohydrocarbon (HFO-1234ze), and compressed gas such as carbon dioxide (CO₂), nitrogen (N₂) and nitrous oxide (N₂O) may be used.

The main body 41 has a cylindrical shape with a diameter that is larger than that of the aerosol container 60. The main body 41 of the present example is sandwiched between the first end cover unit 43 and the second end cover unit 44.

The first end cover unit 43 covers one end portion of the main body 41. The first end cover unit 43 of the present example covers an end portion of an injection side of the aerosol container 60. The first end cover unit 43 is screwed and fixed to the main body 41 to be detachable via a screw unit 45. The first end cover unit 43 of the present example has a dome-shaped covering main body. Considering the aerodynamic characteristics, the diameter of the first end cover unit 43 is reduced such that the diameter is gradually reduced toward the tip. The first end cover unit 43 has a conical or dome-shaped curved surface with a rounded tip. In this way, by making the first end cover unit in a shape having a good aerodynamic characteristic, the effect by a cross-wind is reduced, so that the flight can be stabilized.

In the main body 41, the second end cover unit 44 covers the other end portion which is different from the end portion covered by the first end cover unit 43. The second end cover unit 44 of the present example covers an end portion at an opposite side to the injection side of the aerosol container 60. The second end cover unit 44 is integrally configured with the main body 41. In addition, the second end cover unit 44 may be provided to be removable from the main body 41.

The discharge drive unit 80 discharges the contents from the aerosol container 60. The discharge drive unit 80 is housed in the second end cover unit 44 which is located on a bottom side of the aerosol container 60. The second end cover unit 44 functions as a housing of the discharge drive unit 80. The discharge drive unit 80 includes a cam 81, a cam follower 82 and a movable plate 83. Since the discharge drive unit 80 is provided in the container holding unit 40, the discharge drive unit 80 does not need to be replaced when replacing the aerosol container 60.

The cam 81 is rotationally driven by a driving source. In one example, a motor is used as the driving source. The cam 81 has a structure with a different distance from the rotational center to the outer circumference. Note that the shape of the cam 81 is exaggerated in the illustrated example. The cam 81 is in contact with the cam follower 82 at the outer circumference.

The cam follower 82 is provided between the cam 81 and the movable plate 83. The cam follower 82 is connected to the cam 81 and the movable plate 83 to convey a rotation movement of the cam 81 to the movable plate 83 as a linear movement.

The movable plate 83 is provided to be in contact with the bottom surface of the aerosol container 60 and controls opening and closing of a valve of the aerosol container 60. The movable plate 83 moves back and forth by the cam follower 82. For example, when a distance between the rotational center of the cam 81 and a contact region of the cam 81 where the cam follower 82 abuts is short, the movable plate 83 is retracted with respect to the aerosol container 60 and closes the valve of the aerosol container 60. On the other hand, when a distance between the rotational center of the cam 81 and a contact region of the cam 81 where the cam follower 82 abuts is long, the movable plate 83 moves forward with respect to the aerosol container 60 and opens the valve of the aerosol container 60.

Note that the discharge drive unit 80 has a configuration in which a rotation movement of the motor is converted into a linear movement by a cam mechanism, but it is not limited to the cam mechanism. For example, the mechanism of the discharge drive unit 80 may be any mechanism such as a screw feed mechanism or a rack and pinion, which converts a rotation movement of the motor into a linear movement. In addition, as a driving source, a linear motor for linear driving or an electromagnetic solenoid or the like may be included rather than the rotational motor.

A stem 145 is provided to the aerosol container 60. By pressing the stem 145 by an actuator 143, the contents are discharged from the aerosol container 60. The actuator 143 has a flow channel.

Note that, in the present example, the aerosol container 60 is directly mounted to the container holding unit 40, but the aerosol container 60 may be accommodated by a housing component and the housing component may be mounted to the container holding unit 40. In this case, since the housing component protects the aerosol container 60 from an impact, the safety in an accident is improved.

Also, instead of mounting the aerosol container 60 to the container holding unit 40 to control the discharge from the aerosol container 60 by the discharge drive unit 80 or the like as in the present example, the aerosol container 60 may be directly connected to the first connecting unit 522 and control the discharge from the aerosol container 60 by opening and closing the first switching unit 524.

The aerosol container 60 can be readily replaced by only mounting a new aerosol container 60 even when it becomes empty. In addition, the contents are less likely to attach to the human body, which results in the high safety when being replaced. In addition, it is possible to configure the pressurizing unit 520 with a plurality of aerosol containers 60 including the filling materials with different compositions and concentrations and to perform an injection from the respective aerosol containers 60, thereby providing the contents of the holding container 510 with a desired composition and concentration. For example, by jointly using LPG gas and carbon dioxide, it is possible to manage a concentration of combustible gas within a tank to be out of the explosion range, so that the safety within the tank can be improved. Note that it may be achieved by mounting a plurality of aerosol containers 60.

According to the discharge apparatus 500 of the present example, since the contents can be discharged without using a heavy load such as a pump, the entire weight of the discharge apparatus can be reduced. In addition, since the holding container 510 is pressurized by using a gas pressure by the aerosol container 60 of the pressurizing unit 520, the entire holding container 510 can be quickly pressurized. Furthermore, since the discharge is performed with a positive pressure type by pressurizing the holding container 510, the intensity of the holding container 510 may be lower compared to the case in which the discharge is performed from the holding container 510 with a negative pressure type using the pump, and a lighter material can be used for the holding container 510. Also, since the pump is not used, the contents can be prevented from being warmed due to heat generated from the pump.

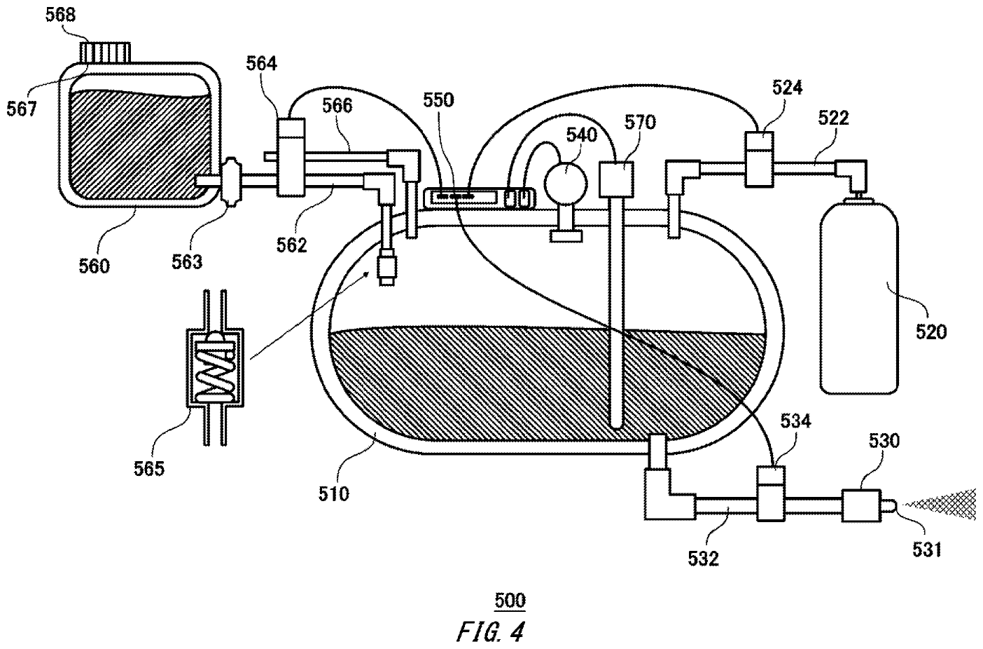

FIG. 4 shows another example of the discharge apparatus 500 in the unmanned aerial vehicle 100.

The discharge apparatus 500 of the present example further includes a supplying container 560 and a remaining amount detection unit 570, in addition to the components of the discharge apparatus 500 according to FIG. 3A. Also, in the discharge apparatus 500 of the present example, instead of the holding container inlet 517 and the holding container cap 518 of the holding container 510 in FIG. 3A, a supplying container inlet 567 and a supplying container cap 568 are provided to the supplying container 560, which are for supplementing the contents to the supplying container 560.

The supplying container 560 holds the contents to be discharged from the discharge apparatus 500 and supplies the contents to the holding container 510. The supplying container 560 may be a tank or a pouch, for example. The supplying container 560 is connected to the holding container 510 by a third connecting unit 562. The third connecting unit 562 has a third switching unit 564 between the supplying container 560 and the holding container 510. The third switching unit 564 is a solenoid valve, for example, like the first switching unit 524 and the second switching unit 534, is electrically connected to the control unit 550, and switches, by opening and closing depending on an electrical signal from the control unit 550, whether the holding container 510 and the supplying container 560 communicate with each other. The supplying container 560 discharges the contents by a pump 563 which is provided on one end side of the third connecting unit 562, and supplies the contents to the holding container 510 through a check valve 565 which is provided on the other end side of the third connecting unit 562. In the present example, further provided is an air releasing unit 566 which connects the holding container 510 and an external space of the discharge apparatus 500 via the third switching unit 564. The air releasing unit 566 depressurizes the holding container 510 when opening the third switching unit 564 for supplying the contents from the supplying container 560 to the holding container 510. Herein, depressurize may refer to releasing the inner pressure of the holding container 510 into an atmospheric pressure. In this way, even in the case where a liquid pressure generated from the pump 563 is low, the contents are supplied to the holding container 510. The check valve 565 has a function to prevent the contents from backflowing into the third connecting unit 562. The air releasing unit 566 may be connected to the external space via a fourth switching unit (not shown) which is different from the third switching unit, without the third switching unit.

The remaining amount detection unit 570 is configured to detect the remaining amount of the contents which the holding container 510 is holding, and outputs the detected remaining amount of the contents to the control unit 550. The control unit 550 may control the operation of the third switching unit 564 depending on the detection result of the remaining amount detection unit 570. For example, if the remaining amount of the contents in the holding container 510 falls below a predetermined lower threshold, the control unit 550 may open the third switching unit 564 to supply the contents from the supplying container 560 to the holding container 510. Moreover, when the remaining amount of the contents in the holding container 510 exceeds a predetermined upper threshold, the control unit 550 may close the third switching unit 564 to stop supplying the contents.

The holding container 510 requires a pressure resistance that is not damaged due to pressurizing by the pressurizing unit 520. On the other hand, the supplying container 560 may have a lower pressure resistance than the holding container 510 since it is not affected due to pressurizing by the pressurizing unit 520. Therefore, for the supplying container 560, a lighter material than that of the holding container 510 can be used. Accordingly, by designing the capacity of the supplying container 560 to be larger than the capacity of the holding container 510, the entire weight of the discharge apparatus 500 can be reduced.

The control unit 550 may be mounted to the holding container 510 as shown in FIG. 3A and FIG. 4, but it may be mounted to another section of the discharge apparatus 500, or may be integrated into, without being included in the discharge apparatus 500, for example, the main body unit 10 of the unmanned aerial vehicle 100. The control unit 550 may perform the control according to the operation conducted by the user, or may perform the control as programmed in advance. Also, the control unit 550 has a wired connection with the first switching unit 524, the second switching unit 534, the third switching unit 564, the inner pressure detection unit 540 and the remaining amount detection unit 570 in FIG. 3A and FIG. 4, but the control unit 550 may control them by wireless communication. Note that in FIG. 3A and FIG. 4, the first switching unit 524, the second switching unit 534, the third switching unit 564, the inner pressure detection unit 540 and the remaining amount detection unit 570 are connected to a single control unit 550, but one or plurality of them may be controlled by another control unit.

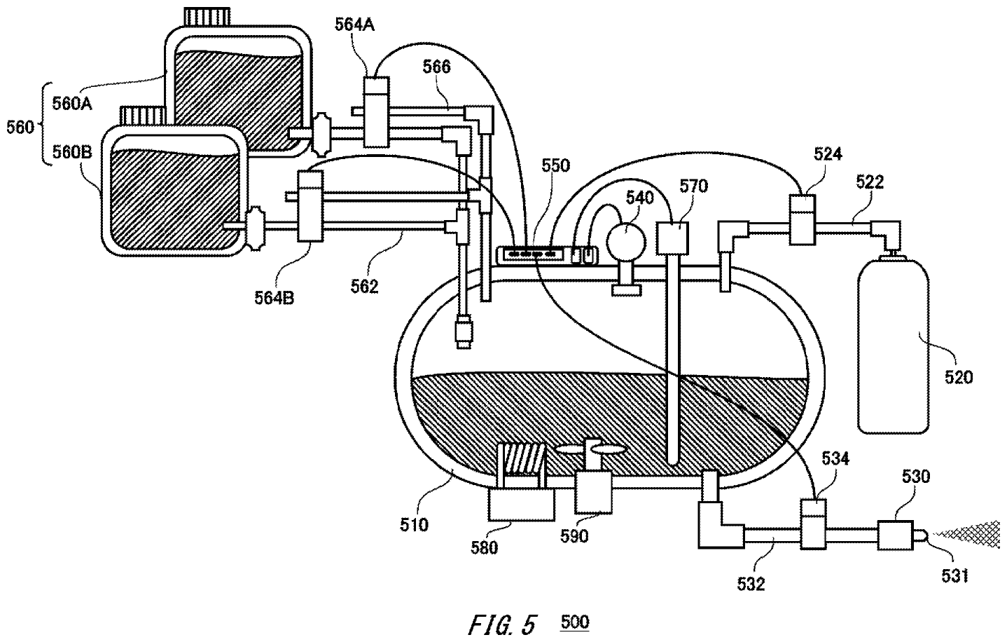

FIG. 5 shows a still another example of the discharge apparatus 500 in the unmanned aerial vehicle 100.

The discharge apparatus 500 of the present example is different from the discharge apparatus 500 according to FIG. 4 in that the supplying container 560 includes the first supplying unit 560A and the second supplying unit 560B and further includes a temperature regulating unit 580 and a stirring unit 590. In the present example, the third connecting unit 562 connects the first supplying unit 560A and the second supplying unit 560B to the holding container 510, respectively via the third switching units 564A and 564B. The third switching units 564A and 564B are independently controlled by the control unit 550, such that the supply of the contents from the first supplying unit 560A and the second supplying unit 560B are independently controlled. In addition, in the present example, the air releasing unit 566 connects the holding container 510 and the external space of the discharge apparatus 500 via the third switching units 564A and 564B. The other components for the discharge apparatus 500 of the present example may be similar to those of the discharge apparatus 500 according to FIG. 4.

The first supplying unit 560A holds a first content and supplies the first content to the holding container 510. The second supplying unit 560B holds a second content and supplies the second content to the holding container 510. The first content and the second content may be contents of different types. For example, the first content and the second content may be two types of liquids which cannot be blended each other, such as a combination of water and liquid oil. Also, the first content and the second content may be two types of materials which generate heat or absorb heat when mixed in the holding container 510. Also, the first content and the second content may be two types of materials which generate a chemical reaction when mixed in the holding container 510. When the two types of contents which generate the chemical reaction are used, in the present drawing, the third connecting unit 562 is connected to the holding container 510 with the first content and the second content merging each other, but a plurality of third connecting units 562 and check valves 565 may be provided. Accordingly, the reaction of contents can be generated only within the holding container 510.

By providing the first supplying unit 560A and the second supplying unit 560B, a plurality of types of contents can be supplied to the holding container 510. In addition, by independently controlling the supply of the contents from the first supplying unit 560A and the second supplying unit 560B, the contents in the holding container 510 can have a desired composition. For example, the first content and the second content may be liquids whose diluting amount needs to be adjusted, such as a combination of pesticide stock solution and water. In this case, among the first supplying unit 560B and the second supplying unit 560B, the one that holds a diluted solution may have a larger volume than the one that holds an undiluted solution. In addition, the first content and the second content may be liquids whose composition needs to be adjusted, such as coating materials with different colors.

Note that the supplying container 560 may include one or plurality of other supplying units in addition to the first supplying unit 560A and the second supplying unit 560B. In this case, each of the other supplying units may hold different types of contents and supply them to the holding container 510.

The temperature regulating unit 580 is configured to regulate the temperature of the contents of the holding container 510. The temperature regulating unit 580 is configured to heat or cool the contents of the holding container 510 or keep the temperature thereof, for example. The temperature regulating unit 580 may be provided within the holding container 510 and regulate the temperature of the contents by perform a heat exchange while directly contacting with the contents. For example, the temperature regulating unit 580 may be a sheathed heater for heating the contents by a nichrome wire covered by a metal tube and an insulator, the nichrome wire being provided within the holding container 510. In addition, the temperature regulating unit 580 may make a heat medium circulate within the metal tube which is provided within the holding container 510 to heat or cool the heat medium or keep the temperature thereof by a temperature regulating apparatus provided outside the holding container 510, thereby performing a temperature regulation. For example, the temperature regulating apparatus provided outside the holding container 510 may be a Peltier device. Alternatively, the temperature regulating unit 580 may be provided outside the holding container 510 to indirectly regulate the temperature of the contents by heating or cooling the holding container 510 or keeping the temperature thereof.

By regulating the temperature of the contents of the holding container 510 using the temperature regulating unit 580, it is possible to discharge the contents with a desired temperature from the discharge unit 530. Also for example, by regulating the temperature of the contents of the holding container 510, the flowability of the contents can be regulated and the contents can be readily discharged from the discharge unit 530. Also for example, by regulating the temperature of the contents of the holding container 510, the inner pressure of the holding container 510 can be changed and the discharge of the contents can be controlled. Furthermore, when the plurality of types of contents are mixed to generate the chemical reaction as mentioned above, the temperature increase of the contents due to the generation of reaction heat can be suppressed. Alternatively, by heating the contents, the chemical reaction can be activated.

The stirring unit 590 is configured to stir the contents of the holding container 510. For example, the stirring unit 590 stirs the contents of the holding container 510 with shaking, sliding, rotating or ultrasonic waves or the like. For example, the stirring unit 590 may be a stirring machine for stirring the contents by rotating the propeller which is provided within the holding container 510. Alternatively, the stirring unit 590 may indirectly stir the contents by vibrating the holding container 510. For example, by installing an ultrasonic device on the outer surface of the holding container 510 and generating an ultrasonic vibration for the holding container 510, the contents can be stirred.

When the first content supplied by the first supplying unit 560A and the second content supplied by the second supplying unit 560B have different compositions, the stirring unit 590 stirs a mixture of the first content and the second content, so that the contents with a desired uniform composition can be discharged from the discharge unit 530. In addition, in a case where the first content and the second content are two types of materials which generate heat or absorb heat when being mixed, the stirring unit 590 mixes the first content and the second content, so that the temperature of the contents of the holding container 510 can be changed. In addition, in a case where the first content and the second content is two types of materials which generate a chemical reaction when mixed, the stirring unit 590 mixes the first content and the second content, thereby the chemical reaction in the holding container 510 can be facilitated. In addition, even in a case where the content is single, the composition of the content can be made uniform by the stirring unit 590. That is, when the content is a liquid including particulates such as a colloidal solution, by the stirring unit 590, the condensing of the particulates can be prevented and the distributed state can be maintained.

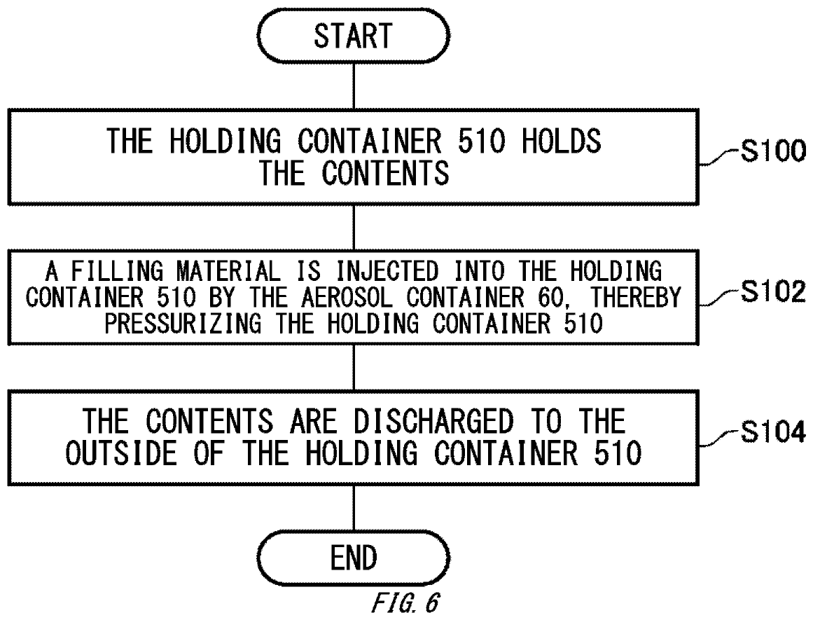

FIG. 6 is a flowchart showing one example of an operation of the discharge apparatus 500 according to FIG. 3A.

In S100, by supplying the contents from the holding container inlet 517, the holding container 510 holds the contents.

In S102, a filling material is injected into the holding container 510 by the aerosol container 60 of the pressurizing unit 520, thereby pressurizing the holding container 510. As described above, when the inner pressure detection unit 540 detects that the inner pressure of the holding container 510 falls below the lower threshold, the control unit 550 may open the first switching unit 524 to perform the pressurizing by the pressurizing unit 520 and when the inner pressure detection unit 540 detects that the inner pressure of the holding container 510 exceeds the upper threshold, the control unit 550 may close the first switching unit 524 to stop the pressurizing which is performed by the pressurizing unit 520. Herein, it should be noted that the operation performed by the pressurizing unit 520 to inject the filling material for pressurizing the holding container 510 may be performed before opening the first switching unit 524 or may be performed after opening the first switching unit 524.

In S104, the contents are discharged to the outside of the holding container 510 by the discharge unit 530. Herein, after performing the pressurizing of S102 in a state where the second switching unit 534 is closed, when the contents of the holding container 510 needs to be discharged from the discharge unit 530, the control unit 550 may open the second switching unit 534 to make the holding container 510 and discharge unit 530 communicate with each other, so that the discharge may be performed by the discharge unit 530. Alternatively, the discharge may be performed by the discharge unit 530 immediately after the pressurizing of S102 in a state where the second switching unit 534 is opened.

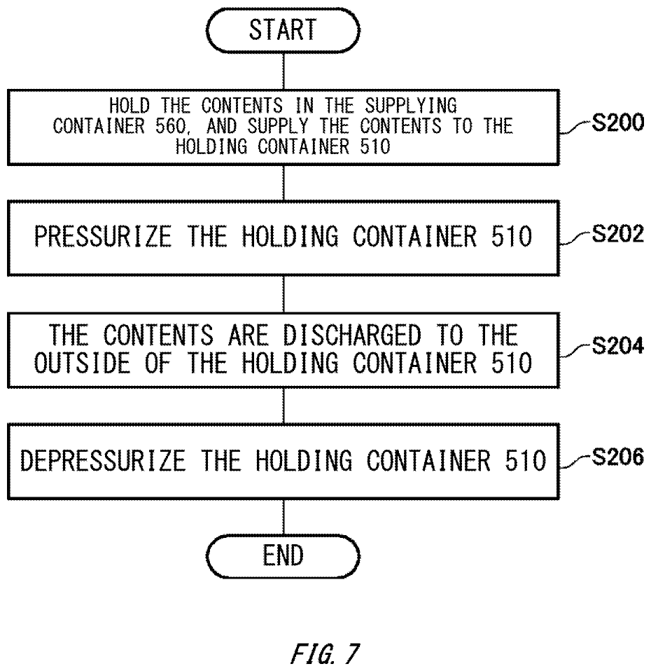

FIG. 7 is a flowchart showing one example of an operation of the discharge apparatus 500 according to FIG. 4.

In S200, by supplying the contents from the supplying container inlet 567, the supplying container 560 holds the contents. Then, the third switching unit 564 is opened to supply the contents from the supplying container 560 to the holding container 510 by the pump 563 of the third connecting unit 562. As described above, when the remaining amount detection unit 570 detects that the remaining amount of the holding container 510 falls below the lower threshold, the control unit 550 may open the third switching unit 564 to perform the supplying by the supplying container 560, and when the remaining amount detection unit 570 detects that the remaining amount of the holding container 510 exceeds the upper threshold, the control unit 550 may close the third switching unit 564 to stop the supplying which is performed by the supplying container 560.

In S202, a filling material is injected into the holding container 510 by the pressurizing unit 520, thereby pressurizing the holding container 510. At this time, the pressurizing may be performed by the pressurizing unit 520 in a state where the third switching unit 564 is closed so that the pressure does not escape from the air releasing unit 566 which is connected to the third switching unit 564. Like S102, when the inner pressure detection unit 540 detects that the inner pressure of the holding container 510 falls below the lower threshold, the control unit 550 may open the first switching unit 524 to perform the pressurizing by the pressurizing unit 520 and when the inner pressure detection unit 540 detects that the inner pressure of the holding container 510 exceeds the upper threshold, the control unit 550 may close the first switching unit 524 to stop the pressurizing which is performed by the pressurizing unit 520. The operation performed by the pressurizing unit 520 to inject the filling material for pressurizing the holding container 510 may be performed before opening the first switching unit 524 or may be performed after opening the first switching unit 524.

In S204, the contents are discharged to the outside of the holding container 510 by the discharge unit 530. Herein, after performing the pressurizing of S202 in a state where the second switching unit 534 and the third switching unit 564 is closed, when the contents of the holding container 510 needs to be discharged from the discharge unit 530, the control unit 550 may open the second switching unit 534 to make the holding container 510 and discharge unit 530 communicate with each other, so that the discharge may be performed by the discharge unit 530. Alternatively, the discharge may be performed by the discharge unit 530 immediately after the pressurizing of S202 in a state where the second switching unit 534 is opened and the third switching unit 564 is closed.

After performing the discharge in S204, the depressurizing of holding container 510 in S206 may be performed. Herein, in a state where the first switching unit 524 and the second switching unit 534 are closed, the third switching unit 564 may be opened to release the pressure of the holding container 510 by the air releasing unit 566. Accordingly, for example, a liquefied gas such as LPG which is injected from the pressurizing unit 520 can be prevented from remaining in a liquefied state within the holding container 510.

While the embodiments of the present invention have been described, the technical scope of the present invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the present invention.

The operations, procedures, steps, and stages of each process performed by an apparatus, system, program, and method shown in the claims, specification, or diagrams can be performed in any order as long as the order is not indicated by “prior to,” “before,” or the like and as long as the output from a previous process is not used in a later process. Even if the operation flow is described using phrases such as “first” or “next” in the claims, specification, or diagrams, it does not necessarily mean that the process must be performed in this order.

### EXPLANATION OF REFERENCES

10 main body unit

12 camera

15 leg

20 propulsion unit

21 rotary wing

22 rotation drive unit

24 arm unit

40 container holding unit

41 main body

42 supporting frame

43 first end cover unit

44 second end cover unit

45 screw unit

60 aerosol container

80 discharge drive unit

81 cam

82 cam follower

83 movable plate

100 unmanned aerial vehicle

143 actuator

145 stem

200 terminal device

210 display unit

220 controller

300 steering system

500 discharge apparatus

510 holding container

517 holding container inlet

518 holding container cap

520 pressurizing unit

522 first connecting unit

524 first switching unit

530 discharge unit

531 discharge outlet

532 second connecting unit

534 second switching unit

540 inner pressure detection unit

550 control unit

560 supplying container

560A first supplying unit

560B second supplying unit

562 third connecting unit

563 pump

564 third switching unit

565 check valve

566 air releasing unit

567 supplying container inlet

568 supplying container cap

570 remaining amount detection unit

580 temperature regulating unit

590 stirring unit

1. A discharge apparatus using an aerosol container, comprising:
a holding container for holding contents;
a pressurizing unit configured to inject a filling material into the holding container by the aerosol container to pressurize the holding container; and
a discharge unit configured to discharge the contents to the outside of the holding container.

2. The discharge apparatus according to claim 1, comprising a first switching unit configured to switch whether the holding container and the pressurizing unit communicate with each other.

3. The discharge apparatus according to claim 2, comprising:
an inner pressure detection unit configured to detect an inner pressure of the holding container; and
a control unit configured to, depending on the detection result of the inner pressure detection unit, control an operation of the first switching unit.

4. The discharge apparatus according to claim 3, wherein the control unit is configured to:
open the first switching unit if the inner pressure of the holding container falls below a predetermined lower threshold; and
close the first switching unit when the inner pressure of the holding container exceeds a predetermined upper threshold.

5. The discharge apparatus according to claim 1, comprising a second switching unit configured to switch whether the holding container and the discharge unit communicate with each other,
wherein the discharge apparatus opens the second switching unit at the time of discharging from the discharge unit.

6. The discharge apparatus according to claim 1, comprising a supplying container configured to hold the contents and to supply the contents to the holding container.

7. The discharge apparatus according to claim 6, comprising a third switching unit configured to switch whether the supplying container and the holding container communicate with each other.

8. The discharge apparatus according to claim 7, comprising:
a remaining amount detection unit configured to detect a remaining amount of the contents which the holding container is holding; and
a control unit configured to, depending on the detection result of the remaining amount detection unit, control an operation of the third switching unit.

9. The discharge apparatus according to claim 6, wherein the holding container has a higher pressure resistance than the supplying container.

10. The discharge apparatus according to claim 6, wherein the supplying container has a larger capacity than the holding container.

11. The discharge apparatus according to claim 6, wherein the supplying container includes a first supplying unit configured to supply a first content, and a second supplying unit configured to supply a second content which is different from the first content.

12. The discharge apparatus according to claim 1, wherein the holding container comprises:
a first connecting unit connected to the pressurizing unit; and
a second connecting unit connected to the discharge unit;
wherein in the holding container, the first connecting unit is provided closer to an upper surface side than the second connecting unit.

13. The discharge apparatus according to claim 1, wherein the holding container further comprises an air releasing unit configured to depressurize the holding container.

14. The discharge apparatus according to claim 1, wherein the pressurizing unit includes at least one of liquefied gas or compressed gas.

15. The discharge apparatus according to claim 1, comprising a temperature regulating unit configured to regulate the temperature of the contents of the holding container.

16. The discharge apparatus according to claim 1, comprising a stirring unit configured to stir the contents of the holding container.

17. An unmanned aerial vehicle comprising the discharge apparatus according to claim 1.

18. A discharge method using an aerosol container, comprising:
holding contents of a holding container;
injecting a filling material within the holding container by the aerosol container to pressurize the holding container; and
discharging the contents to the outside of the holding container.

19. The discharge method according to claim 18, comprising:
holding the contents to supply the contents to the holding container,
pressurizing the holding container after the supplying; and
discharging the contents to the outside of the holding container after the pressurizing.

20. The discharge method according to claim 18, further comprising depressurizing the holding container.
